(19) United States
(12) Patent Application Publication
(10) Pub. No.: US 2009/0227299 A1
(43) Pub. Date: Sep. 10, 2009

(54) System and method for providing interchangeable modules for a mobile station

(75) Inventor: Jack D. Seeley, Lawrence, KS (US)

Correspondence Address: DOCKET CLERK, P.O. DRAWER 800889, DALLAS, TX, 75380, US

(73) Assignee: Samsung Electronics Co., Ltd., Suwon-city (KR)

(21) Appl. No.: 12/075,270

(22) Filed: Mar. 10, 2008

(51) Int. Cl. H04M 1/02; H04M 1/00

(52) U.S. Cl. 455/575.1; 455/556.1

(57) ABSTRACT

An interchangeable module for use in a mobile station is provided that includes a housing, a component set, and a mobile station (MS) interface. The housing is designed to allow the interchangeable module to be reversibly coupled to the mobile station. The component set is capable of providing functions associated with a specified feature for the mobile station. The MS interface is capable of providing communication between the interchangeable module and the mobile station.

### TECHNICAL FIELD OF THE INVENTION

The present invention relates generally to mobile stations and, more specifically, to a system and method for providing interchangeable modules for a mobile station.

### BACKGROUND OF THE INVENTION

Wireless communications systems, including cellular phones, paging devices, and personal communication services (PCS) systems, have become ubiquitous in society. These and other types of user devices are frequently provided with additional capabilities, such as cameras, USB connectors, Bluetooth functionality, and the like. However, conventional mobile handsets implement these and other additional hardware capabilities as integrated components that are incapable of being upgraded after the manufacturing process of the handset is completed. Because of this, if components of different qualities are to be made available to consumers, a distinct handset model must be designed and maintained for each of these different quality components. As a result, the practical considerations associated with designing and maintaining different handset models limit the number of different quality components that are actually made available for purchase by consumers.

### SUMMARY OF THE INVENTION

An interchangeable module for use in a mobile station is provided that includes a housing, a component set, and a mobile station (MS) interface.

According to an advantageous embodiment of the present disclosure, the housing is designed to allow the interchangeable module to be reversibly coupled to the mobile station. The component set is capable of providing functions associated with a specified feature for the mobile station. The MS interface is capable of providing communication between the interchangeable module and the mobile station.

According to another embodiment of the present disclosure, a mobile station for use in a wireless network is provided that includes an interchangeable module (IM) controller and an IM interface. The IM controller is capable of allowing the mobile station to operate with one of a plurality of interchangeable modules. The IM interface is capable of providing communication between the one of the interchangeable modules and the IM controller.

According to yet another embodiment of the present disclosure, a method for providing interchangeable modules for use in a mobile station is provided that includes detecting a model-identifying event. A current model identifier is determined for an interchangeable module coupled to the mobile station. The current model identifier is compared to a previous model identifier stored in the mobile station. When the current model identifier is different from the previous model identifier, a model-specific application for the interchangeable module is implemented that is different from a previously implemented model-specific application.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates a wireless network including mobile stations capable of providing interchangeable modules according to one embodiment of the disclosure;

FIG. 2 is a block diagram of one of the mobile stations of FIG. 1 according to one embodiment of the disclosure;

FIG. 3 is a block diagram of an interchangeable module for use with the mobile station of FIG. 2 according to one embodiment of the disclosure;

FIGS. 4A-4B are block diagrams of an interchangeable module for a mobile station according to one particular embodiment of the disclosure;

FIG. 5 is a block diagram of an interchangeable module for a mobile station according to another particular embodiment of the disclosure; and

FIG. 6 is a flow diagram illustrating a method for providing interchangeable modules for the mobile station of FIG. 2 according to one embodiment of the disclosure.

### DETAILED DESCRIPTION OF THE INVENTION

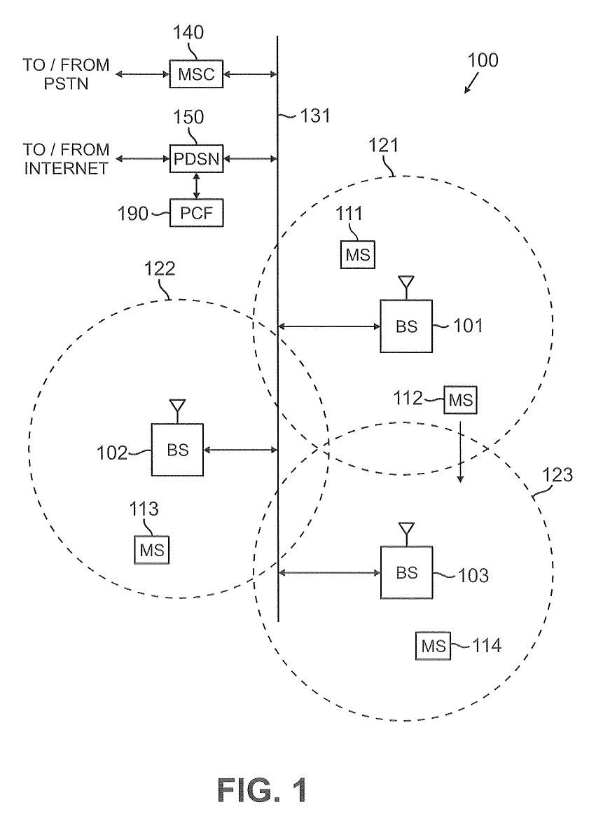

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 illustrates a wireless network 100 that includes mobile stations that are capable of providing interchangeable modules according to the principles of the present disclosure. Wireless network 100 comprises a plurality of cells (or cell sites) 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present disclosure, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present disclosure is not limited to mobile devices. The present disclosure also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cells (or cell sites) 121-123 in which base stations 101-103 are located. It is noted that the terms “cells” and “cell sites” may be used interchangeably in common practice. For simplicity, the term “cell” will be used hereafter. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In one embodiment of the present disclosure, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Alternatively, communication line 131 may be replaced by a wireless backhaul system, such as microwave transceivers. Communication line 131 links each vocoder in the BSC with switch elements in MSC 140. The connections on communication line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the mobile stations in a wireless network and external networks, such as the PSTN or Internet. MSC 140 is well known to those skilled in the art. In some embodiments, communication line 131 may be several different data links where each data link couples one of BS 101, BS 102, or BS 103 to MSC 140.

In wireless network 100, MS 111 is located in cell 121 and is in communication with BS 101. MS 112 is also located in cell 121 and is in communication with BS 101. MS 113 is located in cell 122 and is in communication with BS 102. MS 114 is located in cell 123 and is in communication with BS 103. MS 112 is also located close to the edge of cell 123 and is moving in the direction of cell site 123, as indicated by the direction arrow proximate MS 112. At some point, as MS 112 moves into cell site 123 and out of cell site 121, a hand-off will occur.

In accordance with one embodiment of the present disclosure, one or more of mobile stations 111-114 may comprise the capability to provide interchangeable modules for use in the mobile station 111-114. For a particular example, a mobile station 111-114 may comprise an interchangeable camera module. For this example, the interchangeable camera module may be replaced by a different model in order to upgrade the capabilities of the camera function. In this way, the user of the mobile station 111-114 is able to select a better quality camera for his or her mobile station 111-114 without having to replace the entire mobile station 111-114.

In addition, the mobile station 111-114 may be offered for sale with any one of a variety of interchangeable camera modules, allowing the consumer to select the quality of camera he or she desires upon purchase of the mobile station 111-114. As an option, the consumer may also be able to select a null module that provides no camera function, resulting in a less expensive mobile station 111-114 for the consumer. This also allows the manufacturer of the mobile station 111-114 to design and maintain a single handset model for the mobile station 111-114, instead of designing and maintaining different models of mobile stations 111-114 to provide different quality camera options.

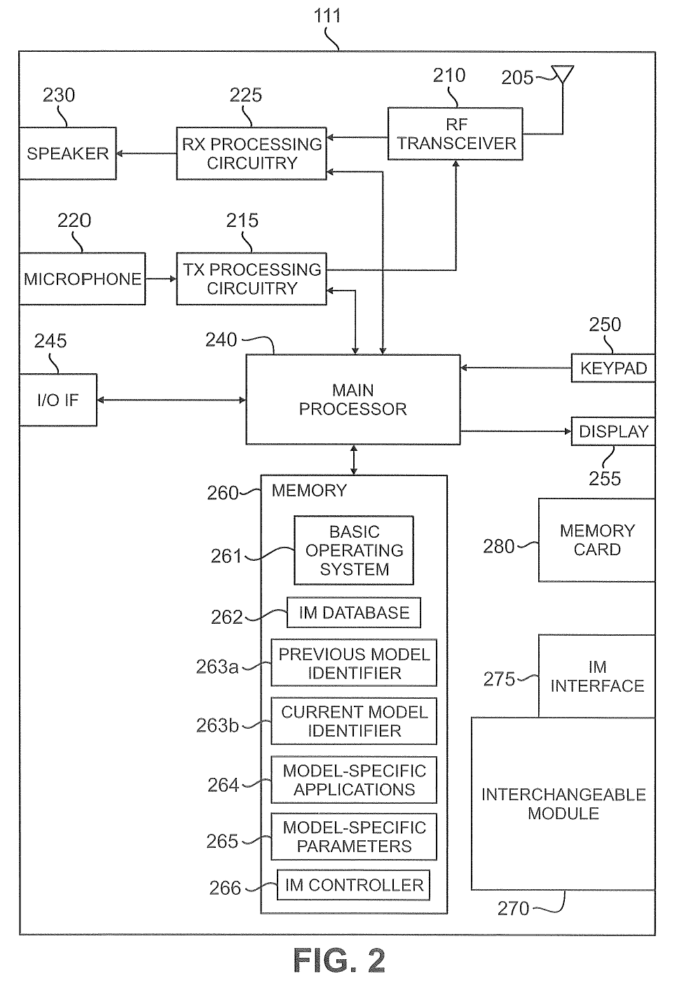

FIG. 2 illustrates wireless mobile station 111 according to an advantageous embodiment of the present disclosure. Wireless mobile station 111 comprises antenna 205, radio frequency (RF) transceiver 210, transmit (TX) processing circuitry 215, microphone 220, and receive (RX) processing circuitry 225. MS 111 also comprises speaker 230, main processor 240, input/output (I/O) interface (IF) 245, keypad 250, display 255, memory 260, interchangeable module 270, interchangeable module (IM) interface 275, and optional memory card 280. Memory 260 further comprises basic operating system program 261, optional IM database 262, model identifiers 263, model-specific applications 264, model-specific parameters 265, and an IM controller 266.

RF transceiver 210 receives from antenna 205 an incoming RF signal transmitted by a base station of wireless network 100. RF transceiver 210 down-converts the incoming RF signal to produce an intermediate frequency (IF) or a baseband signal. The IF or baseband signal is sent to receive processing circuitry 225, which produces a processed baseband signal by filtering, digitizing the baseband or IF signal, additional filtering, if necessary, demodulation and/or decoding. Receive processing circuitry 225 transmits the processed baseband signal to speaker 230 (i.e., voice data) or to main processor 240 for further processing (e.g., web browsing).

Transmit processing circuitry 215 receives analog or digital voice data from microphone 220 or other outgoing baseband data (e.g., web data, e-mail, interactive video game data) from main processor 240. Transmit processing circuitry 215 encodes, modulates, multiplexes, and/or digitizes the outgoing baseband data to produce a processed baseband or IF signal. RF transceiver 210 receives the outgoing processed baseband or IF signal from transmit processing circuitry 215. RF transceiver 210 up-converts the baseband or IF signal to a radio frequency signal that is transmitted via antenna 205.

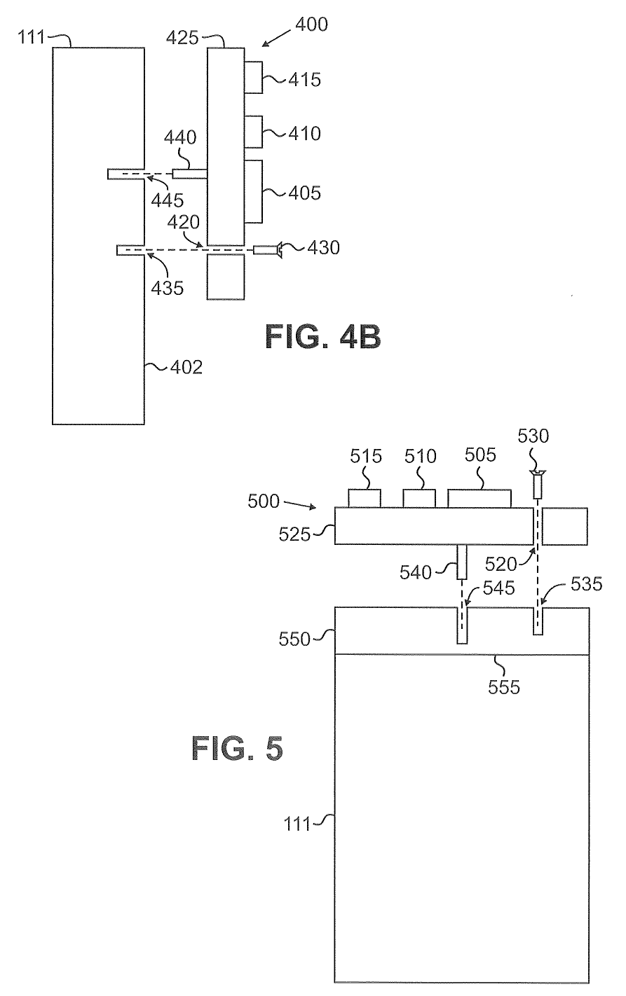

In accordance with one embodiment of the present disclosure, RF transceiver 210 may comprise a receiver architecture that is capable of minimizing the use of an external bandpass filter between a low-noise amplifier (LNA) stage and a first mixer stage in RF transceiver 210. As described in more detail below in connection with FIG. 4, RF transceiver 210 may comprise any suitable number of LNAs in the LNA stage and any suitable number of mixers in the mixer stage.

In an advantageous embodiment of the present disclosure, main processor 240 is a microprocessor or microcontroller. Memory 260 is coupled to main processor 240. According to an advantageous embodiment of the present disclosure, part of memory 260 comprises a random access memory (RAM) and another part of memory 260 comprises a non-volatile memory, such as Flash memory, which acts as a read-only memory (ROM).

Main processor 240 executes basic operating system program 261 stored in memory 260 in order to control the overall operation of wireless mobile station 111. In one such operation, main processor 240 controls the reception of forward channel signals and the transmission of reverse channel signals by RF transceiver 210, receive processing circuitry 225, and transmit processing circuitry 215, in accordance with well-known principles.

Main processor 240 is capable of executing other processes and programs resident in memory 260. Main processor 240 can move data into or out of memory 260, as required by an executing process. Main processor 240 is also coupled to I/O interface 245. I/O interface 245 provides mobile station 111 with the ability to connect to other devices such as laptop computers and handheld computers. I/O interface 245 is the communication path between these accessories and main controller 240.

Main processor 240 is also coupled to keypad 250 and display unit 255. The operator of mobile station 111 uses keypad 250 to enter data into mobile station 111. Display 255 may be a liquid crystal display capable of rendering text and/or at least limited graphics from web sites. Alternate embodiments may use other types of displays.

Interchangeable module 270 is capable of providing a particular feature for the mobile station 111 and is removable and replaceable by another interchangeable module that is capable of providing the same feature. For a particular example, interchangeable module 270 may comprise an interchangeable camera module that is capable of providing a camera feature for the mobile station 111. However, it will be understood that interchangeable module 270 may comprise any other suitable type of module without departing from the scope of this disclosure. For example, interchangeable module 270 may comprise a module that is capable of providing a camcorder, a voice recorder, a music player or any other suitable type of feature for the mobile station 111. Interchangeable module 270 is coupled to IM interface 275. IM interface 275 provides mobile station 111 with the ability to communicate with interchangeable module 270.

For an alternative embodiment, interchangeable module 270 may be capable of providing a particular feature for the mobile station 111 but may be replaced by another interchangeable module 270 that is capable of providing a different feature. For example, interchangeable module 270 may comprise an interchangeable camera module that is capable of providing a camera feature for the mobile station 111. For this alternate embodiment, a user of mobile station 111 may replace interchangeable module 270 with another interchangeable module 270 that is capable of providing a music player for the mobile station 111.

The optional IM database 262 is capable of storing data for interchangeable module 270. For example, for an interchangeable camera module, IM database 262 is capable of storing images captured by the camera functionality of interchangeable module 270. In addition to or instead of IM database 262, mobile station 111 may comprise memory card 280. Memory card 280 comprises an optional, removable data store that is also capable of storing data for interchangeable module 270. For example, for an interchangeable camera module, memory card 280 is capable of storing images captured by the camera functionality of interchangeable module 270. As another alternative, storage may be provided locally within interchangeable module 270 itself.

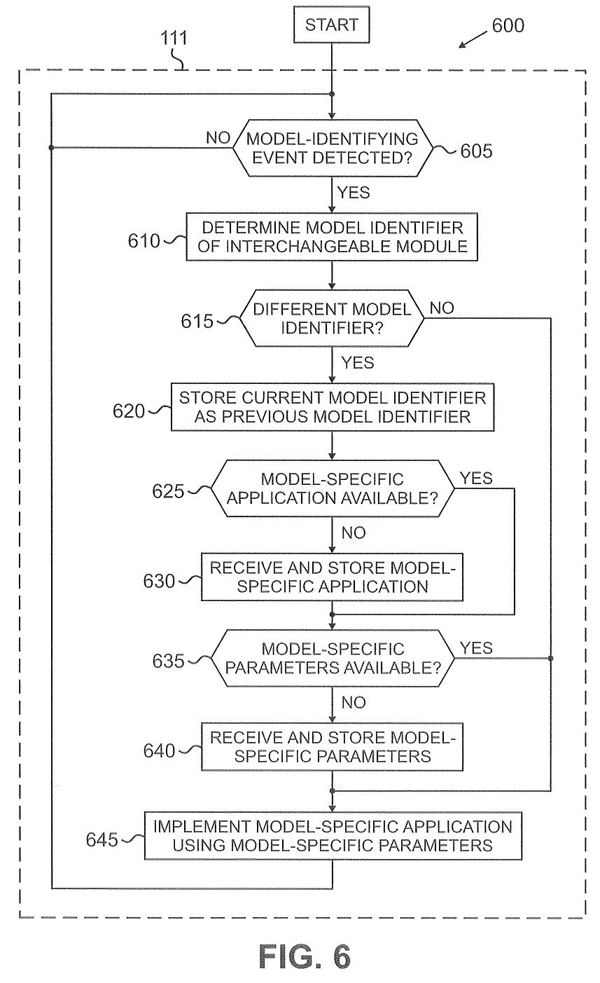

Memory 260 may also store a previous model identifier 263a and a current model identifier 263b. As described in more detail below in connection with FIG. 6, a previous model identifier 263a may correspond to an interchangeable module 270 that has been coupled to mobile station 111 and is currently implemented through a corresponding model-specific application 264 and model-specific parameters 265. A current model identifier 263b may correspond to an interchangeable module 270 that is currently coupled to mobile station 111 and that may or may not have been implemented yet. Thus, when an event occurs that prompts mobile station 111 to determine whether or not interchangeable module 270 has been replaced, a current model identifier 263b for a currently coupled interchangeable module 270 may be compared to the previous model identifier 263a in order to determine whether or not the model of interchangeable module 270 has changed. If such a change is detected, the currently coupled interchangeable module 270 may then be implemented.

Memory 260 may also store one or more model-specific applications 264 that are each capable of providing the software to operate a corresponding model of interchangeable module 270. For some embodiments, memory 260 is capable of storing a model-specific application 264 for each possible interchangeable module 270 that may be used with mobile station 111. For other embodiments, memory 260 may store a number of model-specific applications 264 but not one for each possible interchangeable module 270. For still other embodiments, memory 260 may store only a model-specific application 264 for the interchangeable module 270 currently coupled to mobile station 111.

In addition, memory 260 may also store model-specific parameters 265 for each model-specific application 264 that is stored. For example, the model-specific parameters 265 may include menu keys, control functions, hard keys, soft keys and/or the like that are either in the mobile station's 111 internal software or that are mapped into the software from hardware buttons or controls.

Main processor 240 is also capable of executing IM controller 266, which is a program for communicating with interchangeable module 270. As described in more detail below, IM controller 266 is capable of allowing mobile station 111 to operate with the interchangeable module 270 currently coupled to mobile station 111, which includes responding to the replacement of a first model of interchangeable module 270 with a second model of interchangeable module 270.

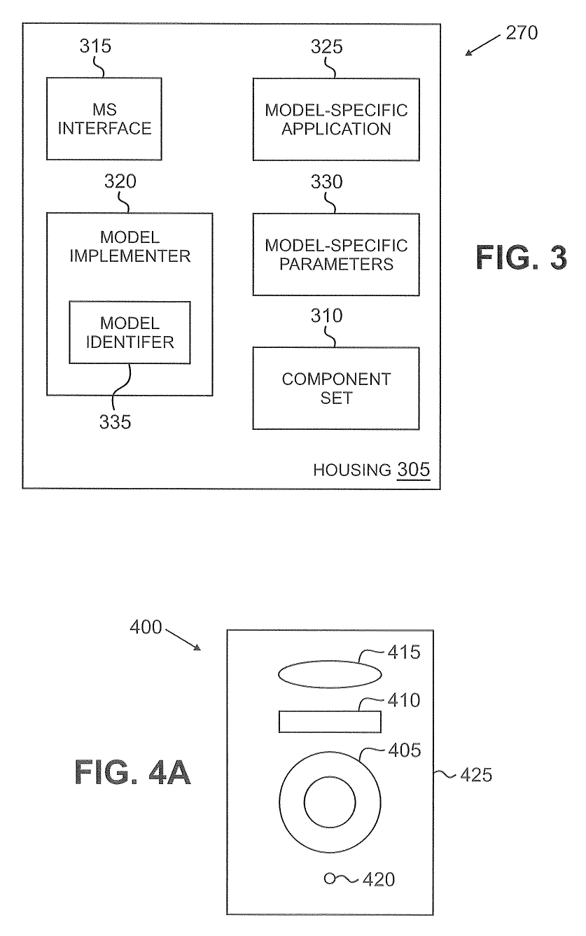

FIG. 3 is a block diagram of an interchangeable module 270 for use with the mobile station 111 according to one embodiment of the disclosure. Interchangeable module 270 may be provided in a housing 305 that encloses and/or is coupled to the additional components of interchangeable module 270. Housing 305 is designed to allow interchangeable module 270 to be interchangeable with other interchangeable modules 270 that share the same housing design. Thus, housing 305 is standardized to fit together with a mobile station 111 regardless of the additional components of interchangeable module 270. In this way, different models of an interchangeable module 270 that provide a same feature (or possibly a different feature) for mobile station 111 may be used in place of each other due to the standardized design of housing 305. Housing 305 may be formed from plastic, metal, composite, ceramic and/or the like, in accordance with the design of the mobile station 111 to which interchangeable module 270 will be coupled.

Interchangeable module 270 may also comprise a component set 310, a mobile station (MS) interface 315, a model implementer 320, a model-specific application 325, and model-specific parameters 330. Component set 310 may comprise the actual hardware and/or software for providing the functionality associated with the feature provided by interchangeable module 270. MS interface 315 is coupled to IM interface 275 of mobile station 111. MS interface 315 provides interchangeable module 270 with the ability to communicate with mobile station 111.

Model implementer 320 is capable of identifying a model of interchangeable module 270 for mobile station 111. For example, for one embodiment, model implementer 320 may be capable of communicating with IM controller 266 in a process that identifies the model. In a particular example, model implementer 320 may store a model identifier 335 that may be used by IM controller 266 to identify the model of the interchangeable module 270.

For some embodiments, model implementer 320 may also be capable of providing model-specific application 325 and/or model-specific parameters 330 to mobile station 111 for storage as a model-specific application 264 and/or model-specific parameters 265, respectively. However, as previously described, if memory 260 stores all possible model-specific applications 264 and model-specific parameters 265, interchangeable module 270 need not include model-specific application 325 and model-specific parameters 330. Similarly, for one embodiment, mobile station 111 may communicate with any suitable component of wireless network 100 in order to request the model-specific application 264 and/or parameters 265. Thus, in this case also, interchangeable module 270 need not include model-specific application 325 and model-specific parameters 330.

For some embodiments, a null interchangeable module 270 may be provided that includes an empty component set 310 in order to provide a standard appearance to mobile station 111 even when the feature made available by interchangeable module 270 is not included with mobile station 111. For this embodiment, a model-specific application 325 and model-specific parameters 330 are also unnecessary for anull interchangeable module 270. The model implementer 320 may be included to communicate with the IM controller 266. However, alternatively, the model implementer 320 may be omitted and the IM controller 266 may be able to determine by its absence that the interchangeable module 270 is a null module.

FIGS. 4A-4B are block diagrams of an interchangeable module 270 for a mobile station 111 according to one particular embodiment of the disclosure. For this particular embodiment, interchangeable module 270 comprises an interchangeable camera module 400 that is coupled to a back side 402 of a mobile station 111. FIG. 4A illustrates a front view of interchangeable camera module 400, while FIG. 4B illustrates a side view of interchangeable camera module 400.

Interchangeable camera module 400 comprises a lens assembly 405, a camera sensor 410, an optional flash 415, and a coupling hole 420, each of which is provided within a housing 425 for interchangeable camera module 400. Housing 425 corresponds to housing 305, while lens assembly 405, camera sensor 410 and flash 415 correspond to component set 310.

Lens assembly 405 comprises one or more lenses for focusing on an image. Camera sensor 410 is capable of sensing light provided through lens assembly 405 in order to capture an image for storage locally within interchangeable camera module 400 or within IM database 262 or memory card 280 of mobile station 111. The optional flash 415 may be used to provide additional light for capturing images. Coupling hole 420 provides a means to attach interchangeable camera module 400 to mobile station 111.

For example, as shown in FIG. 4B, a screw 430 or other suitable coupling mechanism may be inserted through coupling hole 420 and into a corresponding attachment cavity 435 of mobile station 111 in order to hold interchangeable camera module 400 in place on mobile station 111. Also, as shown in FIG. 4B, interchangeable camera module 400 may comprise a pin interface 440 for a printed circuit board (PCB) within mobile station 111, which may have a PCB cavity 445 for receiving the pin interface 440. For this embodiment, the pin interface 440 may represent MS interface 315, while the PCB within mobile station 111 may provide the IM interface 275.

As an alternative to the screw 430 or other device capable of being inserted through coupling hole 420, interchangeable module 400 may comprise no coupling hole 420 and may instead comprise a snapping mechanism or other suitable reversible coupling mechanism to provide selectable attachment and detachment of interchangeable module 400 to and from mobile station 111.

FIG. 5 is a block diagram of an interchangeable module 270 for a mobile station 111 according to another particular embodiment of the disclosure. For this particular embodiment, interchangeable module 270 also comprises an interchangeable camera module 500. However, instead of being coupled to a back side of a mobile station 111, interchangeable camera module 500 is coupled to a top side of a mobile station 111.

Similar to interchangeable camera module 400, interchangeable camera module 500 comprises a lens assembly 505, a camera sensor 510, an optional flash 515, and a coupling hole 520, each of which is provided within a housing 525 for interchangeable camera module 500. Housing 525 corresponds to housing 305, while lens assembly 505, camera sensor 510 and flash 515 correspond to component set 310.

In addition, a screw 530 or other suitable coupling mechanism may be inserted through coupling hole 520 and into a corresponding attachment cavity 535 of mobile station 111 in order to hold interchangeable camera module 500 in place on mobile station 111. Also, interchangeable camera module 500 may comprise a pin interface 540 for a printed circuit board (PCB) within mobile station 111, which may have a PCB cavity 545 for receiving the pin interface 540. For this embodiment, the pin interface 540 may represent MS interface 315, while the PCB within mobile station 111 may provide the IM interface 275.

For the embodiment of FIG. 5, however, coupling hole 520 provides a means to attach interchangeable camera module 500 to an upper portion 550 of mobile station 111. This upper portion 550 of mobile station 111 may be capable of pivoting about an axis 555 in order to allow interchangeable camera module 500 to rotate back and forth. This allows the user of mobile station 111 to select which direction to aim the interchangeable camera module 500 when taking photographs.

FIG. 6 is a flow diagram illustrating a method 600 for providing interchangeable modules 270 for the mobile station 111 according to one embodiment of the disclosure. Initially, IM controller 266 of mobile station 111 determines whether a model-identifying event has been detected (process step 605). A model-identifying event comprises an event that prompts IM controller 266 to identify a model type for interchangeable module 270 in order to determine whether or not a different model of interchangeable module 270 has been coupled to mobile station 111. For example, model-identifying events may comprise a reboot of mobile station 111, insertion of an interchangeable module 270, the operation of a previously implemented model-specific application 264 to provide the feature associated with interchangeable module 270 and/or the like.

Once IM controller 266 detects a model-identifying event (process step 605), IM controller 266 then determines a current model identifier 263b for interchangeable module 270 (process step 610). For example, for one embodiment, IM controller 266 may send a request to interchangeable module 270 to identify itself, and model implementer 320 may send model identifier 335 to IM controller 266 in response. However, it will be understood that IM controller 266 may otherwise suitably determine the current model identifier 263b for interchangeable module 270.

IM controller 266 then compares the current model identifier 263b to a previous model identifier 263a to determine whether or not the model identifier has changed (process step 615). If the model identifier has changed, signifying that a different model of interchangeable module 270 has been coupled to mobile station 111, IM controller 266 stores the current model identifier 263b as the previous model identifier 263a for future comparisons (process step 620).

IM controller 266 then determines whether or not a model-specific application 264 corresponding to the current model identifier 263b is available in mobile station 111 (process step 625). For some embodiments, all possible model-specific applications 264 are stored in memory 260 and, thus, there is no need for IM controller 266 to make this determination. In this case, the method follows the Yes branch. In addition, for other embodiments, mobile station 111 may store only a currently-implemented model-specific application 264. Thus, because a change in model identifiers 263 has been found, there is no need for IM controller 266 to make this determination in this case as well, and the method follows the No branch.

If a model-specific application 264 corresponding to the current model identifier 263b is not available in mobile station 111 (process step 625), mobile station 111 receives and stores a model-specific application 264 for interchangeable module 270 (process step 630). For example, for one embodiment, IM controller 266 may send a request to interchangeable module 270 to provide its model-specific application 325, and model implementer 320 may send model-specific application 325 to mobile station 111 in response. IM controller then 265 stores the received application 325 as the model-specific application 264 in memory 260. However, it will be understood that mobile station 111 may otherwise suitably receive and store a model-specific application 264 for interchangeable module 270. For example, for one embodiment, mobile station 111 may communicate with any suitable component of wireless network 100 in order to request the model-specific application 264.

IM controller 266 may then determine whether or not model-specific parameters 265 corresponding to the current model identifier 263b are available in mobile station 111 (process step 635). For some embodiments, all possible model-specific parameters 265 are stored in memory 260 and, thus, there is no need for IM controller 266 to make this determination. In this case, the method follows the Yes branch. In addition, for other embodiments, mobile station 111 may store only currently-implemented model-specific parameters 265. Thus, because a change in model identifiers has been found, there is no need for IM controller 266 to make this determination in this case as well, and the method follows the No branch.

If model-specific parameters 265 corresponding to the current model identifier 263b are not available in mobile station 111 (process step 635), mobile station 111 receives and stores model-specific parameters 265 for interchangeable module 270 (process step 640). For example, for one embodiment, IM controller 266 may send a request to interchangeable module 270 to provide its model-specific parameters 330, and model implementer 320 may send model-specific parameters 330 to mobile station 111 in response. IM controller then 265 stores the received parameters 330 as the model-specific parameters 265 in memory 260. However, it will be understood that mobile station 111 may otherwise suitably receive and store model-specific parameters 265 for interchangeable module 270. For example, for one embodiment, mobile station 111 may communicate with any suitable component of wireless network 100 in order to request the model-specific parameters 265.

When no change in model identifiers 263 has been found (process step 615), or when model-specific application 264 and model-specific parameters 265 for a new model of interchangeable module 270 are available (process steps 625 and 635) or received and stored (process steps 630 and 640), IM controller 266 implements the model-specific application 264 associated with the current model of interchangeable module 270 using the corresponding model-specific parameters 265 (process step 645) until another model-identifying event is detected (process step 605).

Although the present invention has been described with one embodiment, various changes and modifications may be suggested to one skilled in the art. It is intended that the present invention encompass such changes and modifications as fall within the scope of the appended claims.

What is claimed is:

1. An interchangeable module for use in a mobile station, comprising:
a housing designed to allow the interchangeable module to be reversibly coupled to the mobile station;
a component set capable of providing functions associated with a specified feature for the mobile station; and
a mobile station (MS) interface capable of providing communication between the interchangeable module and the mobile station.

2. The interchangeable module as set forth in claim 1, further comprising a model implementer capable of identifying a model of the interchangeable module.

3. The interchangeable module as set forth in claim 2, wherein the model implementer is further capable of storing a model identifier for the interchangeable module.

4. The interchangeable module as set forth in claim 2, further comprising a model-specific application for the interchangeable module.

5. The interchangeable module as set forth in claim 4, wherein the model implementer is further capable of providing the model-specific application to the mobile station.

6. The interchangeable module as set forth in claim 2, further comprising model-specific parameters for the interchangeable module.

7. The interchangeable module as set forth in claim 6, wherein the model implementer is further capable of providing the model-specific parameters to the mobile station.

8. The interchangeable module as set forth in claim 1, wherein the component set comprises a lens assembly and a camera sensor.

9. The interchangeable module as set forth in claim 1, wherein the MS interface comprises a pin interface for a printed circuit board within the mobile station.

10. The interchangeable module as set forth in claim 1, wherein the housing comprises a coupling hole capable of allowing the interchangeable module to be reversibly coupled to the mobile station.

11. A mobile station for use in a wireless network, comprising:
an interchangeable module (IM) controller capable of allowing the mobile station to operate with one of a plurality of interchangeable modules; and
an IM interface capable of providing communication between the one of the interchangeable modules and the IM controller.

12. The mobile station as set forth in claim 11, the IM controller further capable of detecting a model-identifying event.

13. The mobile station as set forth in claim 12, wherein the model-identifying event comprises at least one of a reboot of the mobile station and insertion of one of the interchangeable modules.

14. The mobile station as set forth in claim 11, wherein the IM controller is further capable of implementing a model-specific application associated with the one of the interchangeable modules based on a model identifier for the one of the interchangeable modules.

15. The mobile station as set forth in claim 11, further comprising memory for storing for the one of the interchangeable modules a model identifier, a model-specific application and model-specific parameters.

16. The mobile station as set forth in claim 11, wherein a first one of the plurality of interchangeable modules is capable of providing functions associated with a first feature for the mobile station, and wherein a second one of the plurality of interchangeable modules is capable of providing functions associated with a second feature for the mobile station.

17. A method for providing interchangeable modules for use in a mobile station, comprising:
detecting a model-identifying event;
determining a current model identifier for an interchangeable module coupled to the mobile station;
comparing the current model identifier to a previous model identifier stored in the mobile station; and
when the current model identifier is different from the previous model identifier, implementing a model-specific application for the interchangeable module different from a previously implemented model-specific application.

18. The method as set forth in claim 17, further comprising, when the current model identifier is different from the previous model identifier, receiving the model-specific application for the interchangeable module from the interchangeable module.

19. The method as set forth in claim 17, further comprising, when the current model identifier is different from the previous model identifier, receiving model-specific parameters for the interchangeable module from the interchangeable module, and wherein implementing the model-specific application for the interchangeable module comprises implementing the model-specific application using the model-specific parameters.

20. The method as set forth in claim 17, wherein the model-identifying event comprises at least one of a reboot of the mobile station and insertion of the interchangeable module.
